(19) United States
(12) Patent Application Publication
(10) Pub. No.: US 2007/0067670 A1
(43) Pub. Date: Mar. 22, 2007

(54) Method, apparatus and program storage device for providing drive load balancing and resynchronization of a mirrored storage system

(75) Inventors: David S. Ebsen, Minneapolis, MN (US); Jeffrey L. Williams, Rochester, MN (US)

Correspondence Address: Crawford Maunu PLLC;Chambliss, Bahner and Stophel, 1000 Tallan Building, Two Union Square, Chattanooga, TN, 37402, US

(73) Assignee: XIOtech Corporation

(21) Appl. No.: 11/229,964

(22) Filed: Sep. 19, 2005

(51) Int. Cl. G06F 11/00

(52) U.S. Cl. 714/7

(57) ABSTRACT

A method, apparatus and program storage device for providing drive load balancing and resynchronization of a mirrored storage system. Data is pushed from a storage device at a source SAN device to a hot spare device of a destination SAN device, wherein the resynchronization rebuild process is incorporated with both the source SAN system and destination SAN system as RAID 0. In another embodiment, the resynchronization rebuild process is incorporated with just the destination SAN system as RAID 0. Nevertheless, RAID 10 performance is provided without the associated cost. A performance gain is provided by using RAID 0, the efficiency of drive space is increased, customer cost is minimized and the time to perform rebuild operations is decreased. Moreover, the present invention provides load balancing to storage devices in enclosures by balancing storage devices between multiple I/O channels.

### BACKGROUND OF THE INVENTION

1. Field of the Invention

This invention relates in general to a data storage systems, and more particularly to a method, apparatus and program storage device for providing drive load balancing and resynchronization of a mirrored storage system.

2. Description of Related Art

The most vulnerable component of a computer system, including cluster systems, are the hard disk drives which contain essentially the only mechanical, moving parts in the otherwise electronic assembly. Data written to a single drive is only as reliable as that drive, and many drives eventually do fail. The data stored on these hard disk drives in many cases represent critical client information, investment information, academic information, or the like. In an age when information storage and access is becoming increasingly important to all enterprises, more reliable methods of data storage are needed.

One existing storage method is a redundant array of independent disks (RAID). RAID systems store and access multiple individual hard disk drives as if the array were a single, larger disk. Distributing data over these multiple disks reduces the risk of losing the data if one drive fails, and it also improves access time. RAID was developed for use in transaction or applications servers and large file servers. Currently, RAID is also utilized in desktop or workstation systems where high transfer rates are needed.

In a cluster environment, RAID and similar shared disk arrays are implemented to provide a client with access to the computing power of the combined nodes together with the large storage capacity of the disk array. A cluster may include a number of nodes, the quantity of which is defined by the storage and computing capacity required. Within each node is a RAID controller. Through the RAID controllers, the nodes transfer data to a RAID array. The RAID controllers communicate with the RAID array through data channels. Elements of a storage system may be coupled to a Local Area Network (LAN) or a private network cable or interconnect. Occasionally, In backup systems where data is mirrored, data is maintained in volume pairs. A volume pair is comprised of a volume in a primary storage device and a corresponding volume in a secondary storage device that includes an identical copy of the data maintained in the primary volume. Typically, the primary volume of the pair will be maintained in a primary direct access storage device (DASD) and the secondary volume of the pair is maintained in a secondary DASD shadowing the data on the primary DASD. A primary storage controller may be provided to control access to the primary DASD and a secondary storage controller may be provided to control access to the secondary DASD.

Typically a RAID is presented to the storage system as a LUN or a mass storage device. In a virtualized system, one or more raids will be combined into what will be referred to in this document as a Virtual Disk (VDisk). A VDisk is simply the logical concatenation of one or more RAIDs. There are many different ways to implement a RAID array, using some combination of mirroring, striping, duplexing and parity technologies. Originally only five primary types of RAID levels were defined, i.e., RAID 1 through RAID 5. Since then, single RAID levels 0 and 6 have been added to the mix, and other extensions have been defined including nested RAID configurations such as RAID 10 and proprietary RAID levels including RAID 1.5 and RAID S. RAIDs 0 and 2-5 employ a technique known as striping that writes a block of data across several hard disk drives. This is a method of combining multiple drives into one logical storage unit. Striping partitions the storage space of each drive into stripes, which can be as small as one sector (typically 512 bytes) or as large as several megabytes. These stripes are then interleaved in a rotating sequence, so that the combined space is composed alternately of stripes from each drive. The specific type of operating environment determines whether large or small stripes are used.

Disk mirroring, whether volume mirroring or RAID type mirroring, can be a very expensive operation in terms of processing time and network bandwidth utilized to write a disk block from volume to its mirror volume. For example, with respect to volume mirroring, after the establishment of a disk mirroring system containing primary and secondary volumes, a synchronization routine establishes a copy of all data contained on the primary volume onto the secondary volume. The secondary volume is referred to as a mirror volume. The synchronization routine begins by reading first data from the primary volume and copying the data to the secondary volume. However, the physical devices may be on either the source or the destination. The failure of a device during mirroring triggers a resynchronization process wherein the mirrored volumes must be made to match through a rebuild process. However, such a rebuild process is time consuming.

In addition to the problem of performing a resynchronization/rebuild operation for a mirrored storage system, the bandwidth to access drives within an enclosure may be affected. More specifically, drive enclosures may include two independent connections providing access to drives therein. When selecting a path from the controller to a drive, the optimum usage alternates between the two paths so that one half of drives are on a first channel (channel A) and half of the drives are on a second channel (channel B). From a system standpoint, half of the drives appear to be in a first enclosure (Box A) and half of the drives appear to be in a second enclosure (Box B). Within a RAID arrangement, drive ordering is based on the boxes. This may result in bottlenecks if, for example, the drives in Box A are all being accessed through a channel A.

It can be seen then that there is a need for a method, apparatus and program storage device for providing drive load balancing and resynchronization of a mirrored storage system.

### SUMMARY OF THE INVENTION

To overcome the limitations in the prior art described above, and to overcome other limitations that will become apparent upon reading and understanding the present specification, the present invention discloses a method, apparatus and program storage device for providing drive load balancing and resynchronization of a mirrored storage system.

The present invention solves the above-described problems by pushing data from a storage device at a source SAN device to a hot spare device of a destination SAN device, wherein the resynchronization rebuild process is incorporated with both the source SAN system and destination SAN system as a chosen RAID configuration. In another embodiment, the resynchronization rebuild process is incorporated with just the destination SAN system as a given RAID configuration. Accordingly, performance is increased without the associated cost. A performance gain is provided, the efficiency of drive space is increased, customer cost is minimized and the time to perform rebuild operations is decreased. An embodiment of the present invention can tolerate a large number of lost drives and loss of remote side change tracking and can be used to help in instances of RAID 5 write holes. Moreover, the present invention provides load balancing to storage devices in enclosures by balancing storage devices between multiple I/O channels.

A storage network for providing resynchronization of a mirrored storage system in accordance with an embodiment of the present invention includes a first storage system, the first storage system comprising a first storage configuration and a second storage system, coupled to the first storage system, the second storage system comprising a mirror of the first storage system, the second storage system configured in a second storage configuration, wherein the second storage system comprises a hot spare storage device for replacing a failed storage device of the first storage system and data is pushed from a source storage device at first storage system to the hot spare storage device of the second storage system to complete resynchronization rebuild of the failed storage device.

In another embodiment of the present invention, a method for providing resynchronization of a mirrored storage system in a storage network is provided. The method includes providing a first storage system, configuring the first storage system in a first storage configuration, providing a second storage system, configuring the second storage system as a mirror of the first storage system using a second storage configuration, providing a hot spare storage device for replacing a failed storage device of the first storage system and pushing data from a source storage device at first storage system to the hot spare storage device of the second storage system to complete resynchronization rebuild of the failed storage device.

In another embodiment of the present invention, a program storage device, that includes program instructions executable by a processing device to perform operations for providing resynchronization of a mirrored storage system in a storage network is provided. The operations include providing a first storage system, configuring the first storage system in a first storage configuration, providing a second storage system, configuring the second storage system as a mirror of the first storage system using a second storage configuration, providing a hot spare storage device for replacing a failed storage device of the first storage system and pushing data from a source storage device at first storage system to the hot spare storage device of the second storage system to complete resynchronization rebuild of the failed storage device.

In another embodiment of the present invention, a system for providing load balancing between storage devices in a storage system is provided. The system includes a controller, the controller providing at least two data channels for communication with storage devices and an enclosure comprising a plurality of storage devices, the enclosure including a first interface card and a interface card, the first and second interface card being used to balance a load between the plurality of storage devices.

In another embodiment of the present invention, a method for providing load balancing between storage devices in a storage system is provided. The method includes providing a controller for providing at least two data channels for communication with storage devices, providing an enclosure including a plurality of storage devices and providing a first interface card and a second interface card for balancing a load between the plurality of storage devices.

In another embodiment of the present invention, a storage network for providing resynchronization of a mirrored storage system and balancing between storage devices in a storage system is provided. The storage network includes a storage controller for providing at least two data channels for communication with storage devices, a first storage system, the first storage system comprising a first storage configuration and a second storage system, coupled to the first storage system, the second storage system comprising a mirror of the first storage system, the second storage system configured in a second storage configuration, wherein at least one of the first storage system and the second storage system includes an enclosure comprising a plurality of storage devices, the enclosure including a first interface card and a second interface card, the first and second interface card being used to balance a load between the plurality of storage devices and wherein the second storage system comprises a hot spare storage device for replacing a failed storage device of the first storage system and data is pushed from a source storage device at first storage system to the hot spare storage device of the second storage system to complete resynchronization rebuild of the failed storage device.

In another embodiment of the present invention, a storage network for providing resynchronization of a mirrored storage system is provided. The storage network includes first means for storing data, the first means for storing data being configured in a first RAID level and second means for storing data, coupled to the first means for storing data, the second means for storing data being configured in a second RAID level and mirroring data of the first means for storing data, wherein the second means for storing include means for providing a hot spare for replacing a failed storage device of the first means for storing data and receiving data pushed from the first means for storing data to complete resynchronization rebuild of a failed storage device of the second means for storing.

In another embodiment of the present invention, a system for providing load balancing between storage devices in a storage system is provided. The system includes means for controlling data storage and providing at least two data channels for communication with means for storing data and means for providing a plurality of means for storing data, the means for providing a plurality of means for storing data including means for providing a first interface and means for providing a second interface, the means for providing the first and second interface being used to balance a load between the plurality of means for storing data.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a network computing environment in which aspects of the invention may be implemented;

FIG. 2 shows a storage network according to an embodiment of the present invention;

FIG. 3 illustrates failure of a disk drive in the destination SAN system according to the present invention;

FIG. 4 illustrates communication between the source SAN device and the destination SAN device according to an embodiment of the present invention;

FIG. 5 illustrates the resynchronization rebuild of the failed disk drive on the hot spare in the destination SAN device according to an embodiment of the present invention;

FIG. 6 illustrates a controller or system is a storage system according to an embodiment of the present invention; and

FIG. 7 illustrates a drive configuration for providing load balancing according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device for providing drive load balancing and resynchronization of a mirrored storage system. Data from a storage device at a source SAN device is pushed to a hot spare device of a destination SAN device, wherein the resynchronization rebuild process is incorporated with both the source SAN system and destination SAN system as a chosen RAID configuration. In another embodiment, the resynchronization rebuild process is incorporated with just the destination SAN system as a given RAID configuration. Accordingly, performance is increased without the associated cost. A performance gain is provided, the efficiency of drive space is increased, customer cost is minimized and the time to perform rebuild operations is decreased. An embodiment of the present invention can tolerate a large number of lost drives and loss of remote side change tracking and can be used to help in instances of RAID 5 write holes. Moreover, the present invention provides load balancing to storage devices in enclosures by balancing storage devices between multiple I/O channels.

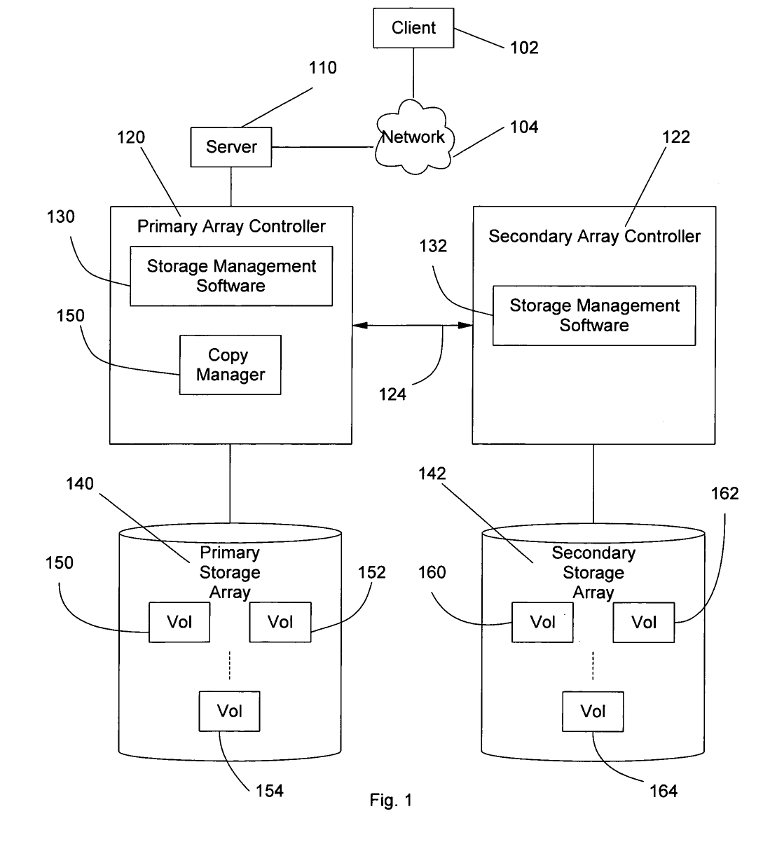

FIG. 1 illustrates a network computing environment 100 in which aspects of the invention may be implemented. A client 102 is coupled to at least one server 110 via a network 104. The at least one server 110 is coupled to a primary array storage controller 120. The primary array controller 120 and a secondary array controller 122 communicate over a connection 124. The storage array controllers 120, 122 each have storage management software 130, 132 and attached storage array systems 140, 142. The storage array systems 140 and 142 include volumes 150, 152, . . . 154 and 160, 162, . . . 164, respectively. The storage array controllers 120, 122 may be situated with respect to each other in a relatively close geographical area, such as a same building, different buildings in a same campus, a same city, etc. or at distant geographical locations, such as different continents, thousands of miles apart, etc. The connection 124 between the storage array controllers 120, 122 may comprise a dedicated line or network, such as a fibre optical connection, Storage Area Network (SAN), Local Area Network (LAN), etc. Alternatively, the connection 124 may comprise an Intranet or the Internet. Server 110 provides support to applications running on client 102 and performs Input/Output (I/O) operations with respect to volumes in the storage array systems 140, 142.

The storage array controllers 120, 122 may further include a processor complex (not shown) and may comprise any storage controller or server known in the art. The storage systems 140, 142 may comprise an array of storage devices, e.g., Redundant Array of Independent Disks (RAID) array, virtualization device, etc. The storage management software 130, 132 may include code to allow for mirroring of data and data recovery in the event of a failure and to allow for mirroring of data over relatively short and long distances. The storage management software 130, 132 is operatively coupled to a copy manager 150 for identifying the volume pairs, i.e., source tracks and corresponding target tracks that are included in a copy relationship, such that tracks in the source volumes may be mirrored to tracks in the target volumes.

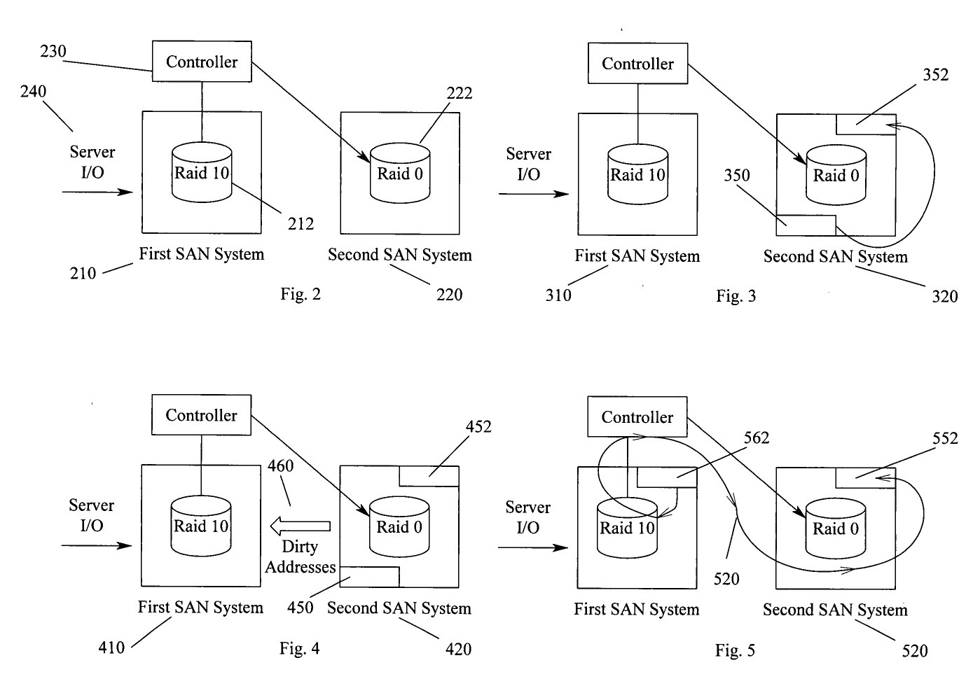

FIG. 2 shows a storage network 200 according to an embodiment of the present invention. In FIG. 2, a first storage area network (SAN) system 210 is configured in a RAID 10 configuration 212. A second SAN system 220 is coupled to the first SAN system 210 in a mirrored arrangement via controller 230. The second SAN system 220 is configured in a RAID 0 configuration 222. Server I/O 240 provides data to the first SAN system 210. By way of example, the first SAN system 210 will be referred to as the source SAN system and the second SAN system 220 will be referred to as the destination SAN system. Volumes on destination SAN system 220 include mirrored volumes of volumes on the source SAN system 210. With mirrored volumes, the mirror may be deleted, repaired or resynchronized (resync) with the source SAN volumes 210.

FIG. 3 illustrates failure of a disk drive in the destination SAN system 300 according to the present invention. Likewise in FIG. 3, volumes on destination SAN system 320 include mirrored volumes of volumes on the source SAN system 310. However, FIG. 3 shows failure of a disk drive 350 in the destination SAN system 320. FIG. 3 shows that in the event of failure of a physical device 350 on the destination SAN device 320, a hot spare 352 is assigned the stripes of the failing device 350. RAID 0 virtual disks (VDisks) are used for the destination of a resynchronization mirror set.

FIG. 4 illustrates communication 400 between the source SAN device and the destination SAN device according to an embodiment of the present invention. Once the hot spare 452 is assigned the stripes of the failing device 450, the destination SAN device 420 with the failing device 450 then reports dirty address to a copy manager (not shown in FIG. 4; see in copy manager 150 in FIG. 1) for the first SAN system 410. The copy manager typically resides at the source SAN device 410. The destination SAN device 420 reports to the copy manager via a communication link 460, e.g., over redundant fibre or locally, that the segments of data contained on the failed physical device are now dirty and must be re-copied.

FIG. 5 illustrates one example of a resynchronization rebuild 500 of a failed disk drive (not shown in FIG. 5) on a hot spare 552 in a destination SAN device 520 according to one embodiment of the present invention. In FIG. 5, data is pushed from a storage device 562 at the source SAN device 510 to the hot spare 552 device of the destination SAN device 520. For example, the data transfer rate from the source SAN device 510 to the hot spare 552 of the destination SAN device 520 may be at a rate of approximately 20 MB/s. At this rate a rebuild of a 180 GB drive hot spare 552 would take 2½ hours. However, those skilled in the art will recognize that the present invention is not meant to be limited to a particular transfer rate or storage capacity. Rather, the values above are provided only as an example. The resynchronization rebuild process 570 may be incorporated with both the source SAN system 510 and destination SAN system 520 as a particular RAID configuration. In another embodiment, the resynchronization rebuild process is incorporated with just the destination SAN system 530 configured differently than the source SAN system 510. Nevertheless, both embodiments yield performance improvements without the associated cost. Accordingly, a simplistic version of RAID logic may be moved into the re-sync code. RAID VDisks provided by hot spare 552 are used for the destination of the re-sync mirror set. The process described with reference to FIGS. 2-5 provides a performance gain from and increases the efficiency of drive space. Furthermore, the above-described process minimizes customer cost and decreases the time to perform rebuild operations.

The above process may use RAID 0 VDisks for the destination SAN system 520. Further, embodiments of the present invention may be configured using RAID 0 VDisks for the destination 520 and/or source 510 of a resynchronization mirror set. Thus, in the event of a failure on either the source or the destination SAN system, a hot spare 552 as shown in destination SAN system 520 can be assigned the stripes of the failing device.

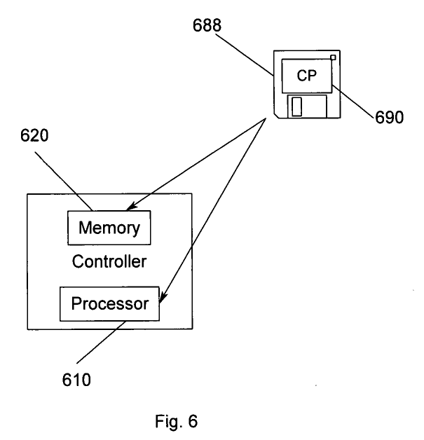

FIG. 6 illustrates a controller or system 600 in a storage system according to an embodiment of the present invention. The system 600 includes a processor 610 and memory 620. The processor controls and processes data for the storage controller 600. The process illustrated with reference to FIGS. 1-5 may be tangibly embodied in a computer-readable medium or carrier, e.g., one or more of the fixed and/or removable data storage devices 688 illustrated in FIG. 6, or other data storage or data communications devices. The computer program 690 may be loaded into memory 620 to configure the processor 610 for execution. The computer program 690 include instructions which, when read and executed by a processor 610 of FIG. 6 causes the processor 610 to perform the steps necessary to execute the steps or elements of the present invention.

As mentioned above, in addition to the problem of performing a resynchronization/rebuild operation, the bandwidth to access drives within an enclosure may be affected. More specifically, drive enclosures may include two independent connections providing access to drives therein. When selecting a path from the controller to a drive, the optimum usage alternates between the two paths so that one half of drives are on a first channel (channel A) and half of the drives are on a second channel (channel B). Within a RAID arrangement, drive ordering is based on the boxes. This may result in bottlenecks if, for example, the drives in Box A are all being accessed through a channel A.

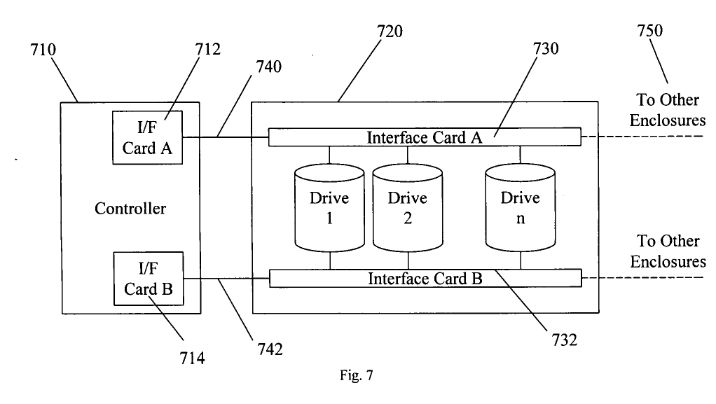

FIG. 7 illustrates a drive configuration for providing load balancing 700 according to an embodiment of the present invention. In FIG. 7, a controller 710 includes a first 712 and second 714 interface card. A first enclosure 720 includes a plurality of disk drives 722, 724, 726. A first 730 and second 732 interface card are coupled to the plurality of disk drives 722, 724, 726, wherein the first interface card 730 is coupled to the first channel 740 via the first interface card 712 and the second interface card 732 is coupled to the second channel 742 via the second interface card 714. The first interface card 712 sees all N drives on the first interface card 730 and the second interface card 714 sees all N drives on the second interface card 732. Additional enclosures 750 are coupled in the same manner.

Alternating drive lists are reported to a controller 710 between two data channels 740, 742 so that every other device of storage device 722, 724, 726 is on a first channel 740 and the remaining alternating device of storage devices 722, 724, 726 are on the second data channel 742. Alternatively, the number of drives, n, are determined and n/2 of the storage devices 722, 724, 726 are placed on the first channel 740 and the remaining n/2 storage devices 722, 724, 726 are placed on the second channel 742. Accordingly, all storage devices 722, 724, 726 in the first enclosure 720 are viewed as being on the first channel 740 and the rest are viewed as being on the second channel 742. For each of the channels, a count of the storage devices 722, 724, 726 is maintained. If a storage device 722, 724, 726 is seen on two channels 740, 742, the storage device is placed on the channel with the least devices. Thus, load balancing between storage devices 722, 724, 726 and enclosures 720 may be provided.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A storage network for providing resynchronization of a mirrored storage system, comprising:
a first storage system, the first storage system comprising a first storage configuration; and
a second storage system, coupled to the first storage system, the second storage system comprising a mirror of the first storage system, the second storage system configured in a second storage configuration;
wherein the second storage system comprises a hot spare storage device for replacing an unavailable storage device of the first storage system and data is pushed from a source storage device at first storage system to the hot spare storage device of the second storage system to complete resynchronization rebuild of the unavailable storage device.

2. The storage network of claim 1, wherein the resynchronization rebuild process is incorporated with both the first and second storage system as RAID 0.

3. The storage network of claim 1, wherein the resynchronization rebuild of the unavailable storage device is incorporated with only the second storage system as RAID 0.

4. The storage network of claim 1, wherein the second storage configuration comprises RAID 0 to enable RAID 10 performance without the cost associated with RAID 10.

5. The storage network of claim 1, wherein the hot spare storage device provides recovery of RAID 0.

6. The storage network of claim 1, wherein the hot spare storage device is assigned stripes of the unavailable device.

7. A method for providing resynchronization of a mirrored storage system in a storage network, comprising:
providing a first storage system;
configuring the first storage system in a first storage configuration;
providing a second storage system;
configuring the second storage system as a mirror of the first storage system using a second storage configuration;
providing a hot spare storage device for replacing an unavailable storage device of the second storage system; and
pushing data from a source storage device at first storage system to the hot spare storage device of the second storage system to complete resynchronization rebuild of the unavailable storage device.

8. The method of claim 7 wherein the pushing data to complete resynchronization rebuild of the unavailable storage device comprises incorporating both the first and second storage system as RAID 0.

9. The method of claim 7 wherein the pushing data to complete resynchronization rebuild of the unavailable storage device comprises incorporating only the second storage system as RAID 0.

10. The method of claim 7 wherein the configuring the second storage configuration further comprises configuring the second storage system as RAID 0 to enable RAID 10 performance for the storage network without the cost associated with RAID 10.

11. The method of claim 7, wherein the providing a hot spare storage device further comprises providing recovery of RAID 0 using the hot spare storage device.

12. The method of claim 7, wherein the providing a hot spare storage device further comprises assigning stripes of the unavailable storage device to the hot spare storage device.

13. A program storage device, comprising:
program instructions executable by a processing device to perform operations for providing resynchronization of a mirrored storage system in a storage network, the operations comprising:
providing a first storage system;
configuring the first storage system in a first storage configuration;
providing a second storage system;
configuring the second storage system as a mirror of the first storage system using a second storage configuration;
providing a hot spare storage device for replacing an unavailable storage device of the first storage system; and
pushing data from a source storage device at first storage system to the hot spare storage device of the second storage system to complete resynchronization rebuild of the unavailable storage device.

14. The program storage device of claim 13, wherein the pushing data to complete resynchronization rebuild of the unavailable storage device comprises incorporating both the first and second storage system as RAID 0.

15. The program storage device of claim 13, wherein the pushing data to complete resynchronization rebuild of the unavailable storage device comprises incorporating only the second storage system as RAID 0.

16. The program storage device of claim 13, wherein the configuring the second storage configuration further comprises configuring the second storage system as RAID 0 to enable RAID 10 performance for the storage network without the cost associated with RAID 10.

17. The program storage device of claim 13, wherein the providing a hot spare storage device further comprises providing recovery of RAID 0 using the hot spare storage device.

18. The program storage device of claim 13, wherein the providing a hot spare storage device further comprises assigning stripes of the unavailable storage device to the hot spare storage device.

19. A system for providing load balancing between storage devices in a storage system, comprising:
a controller, the controller providing at least two data channels for communication with storage devices; and
an enclosure comprising a plurality of storage devices, the enclosure including a first interface card and a second interface card, the first and second interface card being used to balance a load between the plurality of storage devices.

20. The system of claim 19, wherein the controller further includes at least a two interface cards for providing the at least two data channels.

21. The system of claim 19, wherein the first interface card is coupled to the first channel and the second interface card is coupled to the second channel.

22. The system of claim 19, wherein bandwidth for communicating the plurality of storage devices is balanced between the first and second data channels.

23. The system of claim 22, wherein bandwidth for communicating the plurality of storage devices is balanced between the first and second data channels by alternating device assignments between the first and second data channels.

24. The system of claim 23, wherein the storage devices are seen by the controller as alternating between the first and second data channels by alternating storage device assignments to the first and second interface cards drives.

25. The system of claim 22, wherein bandwidth for communicating with the plurality of storage devices is balanced between the first and second data channels by determining a number of storage devices, n, and assigning n/2 of the storage devices on the first channel and placing the remaining n/2 storage devices on the second channel.

26. The system of claim 19, wherein the controller maintains a count of the storage devices and when a storage device is seen on two channels the storage device is placed on a channel with the least devices.

27. A method for providing load balancing between storage devices in a storage system, comprising:
providing a controller for providing at least two data channels for communication with storage devices;
providing an enclosure including a plurality of storage devices; and
providing a first interface card and a second interface card for balancing a load between the plurality of storage devices.

28. The method of claim 27, wherein the providing a controller further includes providing at least a two interface cards within the controller for providing the at least two data channels to the plurality of storage devices.

29. The method of claim 27, wherein the providing the first and second interface cards comprises coupling the first interface card to the first channel and coupling the second interface card to the second channel.

30. The system of claim 27, wherein the providing the first and second interface cards further comprises balancing the bandwidth of the plurality of storage devices between the first and second data channels.

31. The system of claim 30, wherein the balancing the bandwidth of the plurality of storage devices between the first and second data channels further comprises alternating device assignments between the first and second data channels.

32. The system of claim 31, wherein the alternating device assignments between the first and second data channels further comprises alternating storage device assignments to the first and second interface cards drives.

33. The system of claim 30, wherein the balancing the bandwidth of the plurality of storage devices between the first and second data channels further comprises determining a number of storage devices, n, and assigning n/2 of the storage devices on the first channel and placing the remaining n/2 storage devices on the second channel.

34. The system of claim 27, wherein the providing a first interface card and a second interface card for balancing a load between the plurality of storage devices further comprises maintaining a count of the storage devices and when a storage device is seen on two channels placing a storage device seen on two channels on the channel with a least devices.

35. A storage network for providing resynchronization of a mirrored storage system and balancing between storage devices in a storage system, comprising:
a storage controller for providing at least two data channels for communication with storage devices;
a first storage system, the first storage system comprising a first storage configuration; and
a second storage system, coupled to the first storage system, the second storage system comprising a mirror of the first storage system, the second storage system configured in a second storage configuration;
wherein at least one of the first storage system and the second storage system includes an enclosure comprising a plurality of storage devices, the enclosure including a first interface card and a second interface card, the first and second interface card being used to balance a load between the plurality of storage devices and wherein the second storage system comprises a hot spare storage device for replacing a unavailable storage device of the first storage system and data is pushed from a source storage device at first storage system to the hot spare storage device of the second storage system to complete resynchronization rebuild of the unavailable storage device.

36. A storage network for providing resynchronization of a mirrored storage system, comprising:
first means for storing data, the first means for storing data being configured in a first RAID level; and
second means for storing data, coupled to the first means for storing data, the second means for storing data being configured in a second RAID level and mirroring data of the first means for storing data;
wherein the second means for storing include means for providing a hot spare for replacing a unavailable storage device of the first means for storing data and receiving data pushed from the first means for storing data to complete resynchronization rebuild of a unavailable storage device of the second means for storing.

37. A system for providing load balancing between storage devices in a storage system, comprising:
means for controlling data storage and providing at least two data channels for communication with means for storing data; and
means for providing a plurality of means for storing data, the means for providing a plurality of means for storing data including means for providing a first interface and means for providing a second interface, the means for providing the first and second interface being used to balance a load between the plurality of means for storing data.
